(19) United States
(12) Patent Application Publication
(10) Pub. No.: US 2024/0186684 A1
(43) Pub. Date: Jun. 6, 2024

(54) Electronic Devices With Antenna Mounting Structures

(71) Applicant: Apple Inc., Cupertino, CA (US)

(72) Inventors: Yi Jiang, Cupertino, CA (US); Boon W Shiu, Palo Alto, CA (US); Jason C Sauers, Sunnyvale, CA (US); Jia-Woei Chen, Campbell, CA (US); Killian J Poore, San Jose, CA (US); Lijun Zhang, Los Gatos, CA (US)

(21) Appl. No.: 18/435,423

(22) Filed: Feb. 7, 2024

Related U.S. Application Data
(63) Continuation of application No. PCT/US22/40792, filed on Aug. 18, 2022.
(60) Provisional application No. 63/238,673, filed on Aug. 30, 2021.

(51) Int. Cl. H01Q 1/27

(52) U.S. Cl. CPC H01Q 1/273

(57) ABSTRACT

A head-mounted device may be worn on a head of a user. While the head-mounted device is being worn, optical modules in the head-mounted device may provide images to eye boxes located rearward of the head-mounted device. A forward-facing display on a front portion of the head-mounted device may be covered with a transparent housing portion forming a display cover layer. An antenna may be mounted in the device. An antenna support member may be coupled to the head-mounted housing. A biasing member such as a layer of foam may have first and second opposing surfaces characterized by surface normals. The foam may be characterized by an axis of preferential compression that is not parallel to the surface normals. The support member may press against the foam so that the antenna presses against an edge portion of the display cover layer or other overlapping dielectric layer.

This application is a continuation of international patent application No. PCT/US2022/040792, filed Aug. 18, 2022, which claims priority to U.S. provisional patent application No. 63/238,673, filed Aug. 30, 2021, which are hereby incorporated by reference herein in their entireties.

### FIELD

This relates generally to electronic devices, and, more particularly, to electronic devices such as head-mounted devices with components such as antennas.

### BACKGROUND

Electronic devices such as head-mounted devices may have input-output components. The input-output components may include components such as antennas for handling wireless communications.

### SUMMARY

A head-mounted device may have a head-mounted housing that is configured to be worn on a head of a user. The head-mounted device may have optical modules. The optical modules may be used to provide images to eye boxes in a rearward direction. A display may be mounted on an opposing side of the head-mounted housing, facing forward away from the eye boxes.

The head-mounted device may have transparent housing structures such as glass layers or other transparent layers. A glass layer on the front of the housing may serve as a display cover layer that overlaps the forward-facing display.

The head-mounted device may have wireless circuitry. The wireless circuitry may include radio-frequency transceiver circuitry coupled to one or more antennas. An antenna may be mounted in the device in a location where antenna signals are not blocked by conductive structures. As an example, an antenna may be mounted under an edge portion of the display cover layer. An antenna support member (sometimes referred to as an antenna support structure or antenna support) that is coupled to the head-mounted housing may be used in supporting the antenna.

A biasing member (sometimes referred to as a biasing structure) such as a layer of structured foam may be coupled between the antenna support member and the display cover layer. The biasing member may have first and second opposing surfaces characterized by surface normals. The biasing member may be characterized by an axis of preferential compression that is not parallel to the surface normals. The support member may press against the biasing member, which, in turn, may press the antenna against a curved portion of the display cover layer.

### BRIEF DESCRIPTION OF THE DRAWINGS

FIG. 1 is a top view of an illustrative electronic device such as a head-mounted device in accordance with an embodiment.

FIG. 2 is a diagram of an illustrative antenna for an electronic device in accordance with an embodiment.

FIG. 3 is a perspective view of an illustrative antenna on an illustrative unidirectional structured foam antenna biasing structure in accordance with an embodiment.

FIG. 4 is a top view of an illustrative structured foam member in accordance with an embodiment.

FIG. 5 is a diagram illustrating how a structured foam member may exhibit preferential unidirectional compression and expansion characteristics in accordance with an embodiment.

FIG. 6 is a cross-sectional top view of a right-hand edge portion of an illustrative head-mounted device in which a unidirectional structured foam antenna biasing member (antenna biasing structure) is being used to mount an antenna against a surface of an overlapping layer such as a display cover layer in accordance with an embodiment.

### DETAILED DESCRIPTION

Electronic devices may be provided with component mounting structures. The electronic devices may include portable electronic devices, wearable devices, desktop devices, embedded systems, and other electronic equipment. Illustrative configurations in which the electronic devices include a head-mounted device with a component mounting system may sometimes be described herein as an example.

Component mounting systems may be used to help mount electrical components in a device. As an example, a biasing member (sometimes referred to as a basing structure) may be used to help mount an antenna in the housing of a device. The biasing member, the antenna, and additional structures such as an antenna support member (sometimes referred to as an antenna support structure or antenna support) may form an antenna assembly that helps mount the antenna in a location in the device in which antenna signals are not blocked by conductive housing structures. If desired, biasing members may be used in mounting components other than antennas in a device. The use of biasing members to help mount antennas in head-mounted devices is illustrative.

A biasing member for an antenna assembly may be formed from a material such as structural foam or other compressible material that exhibits unidirectional compression and expansion characteristics. With this type of arrangement, the foam preferentially compresses and expands along a particular direction and exhibits little or no expansion and compression along orthogonal directions. The direction of preferential compression and expansion, which may sometimes be referred to as a preferential compression direction, unidirectional compression direction, preferential compression/expansion axis, axis of preferential compression, etc., need not be parallel with the surface normals of the biasing member. For example, a biasing member may be formed from a layer of foam with first and second opposing surfaces that are characterized by surface normals and the preferential compression direction may be oriented at a non-zero angle (e.g., an angle of at least 10°, at least 20°, less than 80º, less than 70°, or other suitable angle) with respect to the surface normals.

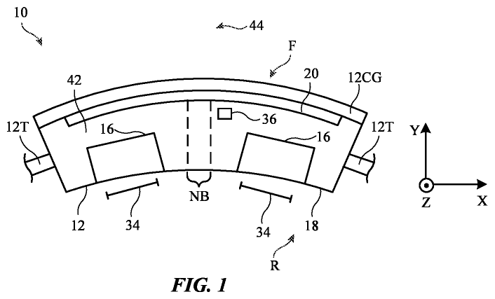

FIG. 1 is a top view of an illustrative electronic device that may include a component biasing member. In the example of FIG. 1, device 10 is a head-mounted device. As shown in FIG. 1, head-mounted device 10 may include housing 12. Housing 12 is configured to be worn on a user's head and may sometimes be referred to as a head-mounted housing or head-mounted support structure. Housing 12 may have curved head-shaped surfaces, a nose-bridge portion such as portion NB that is configured to rest on a user's nose when device 10 is on a user's head, may have a headband such as strap 12T for supporting device 10 on the user's head, and/or may have other features that allow device 10 to be worn by a user. Housing 12 may have walls or other structures that separate an interior region of device 10 such as interior region 42 from an exterior region surrounding device 10 such as exterior region 44. As an example, housing 12 may include a transparent layer that forms a housing wall on front F of device 10 such as display cover layer 12CG. Display cover layer 12CG may overlap a forward-facing display such as display 20 (e.g., a pixel array based on organic light-emitting diodes or other display panel). Electrical components 36 (e.g., integrated circuits, sensors, control circuitry, light-emitting diodes, lasers, and other light-emitting devices, other control circuits and input-output devices, etc.) may be mounted on printed circuits and/or other structures within device 10 (e.g., in interior region 42).

To present a user with images for viewing from eye boxes such as eye box 34, device 10 may include rear-facing displays in optical modules 16. There may be, for example, a left rear-facing display in a left optical module 16 for presenting an image through a left lens to a user's left eye in a left eye box 34 and a right rear-facing display in right optical module 16 for presenting an image through a right lens to a user's right eye in a right eye box 34.

The user's eyes are located in eye boxes 34 at rear R of device 10 when inwardly facing surface 18 of housing 12 rests against the outer surface of the user's face. On rear R, housing 12 may have cushioned structures (sometimes referred to as light seal structures) to enhance user comfort as surface 18 rests against the user's face. Device 10 may have forward-facing components such has forward-facing cameras and other sensors on front F that face outwardly away from the user. These components may generally be oriented in the +Y (forward) direction of FIG. 1.

During operation, device 10 may receive image data (e.g., image data for video, still images, etc.) and may present this information on the displays of optical modules 16. Device 10 may also receive other data, control commands, user input, etc. Device 10 may transmit data to accessories and other electronic equipment. For example, image data from a forward-facing camera may be provided to an associated device, audio output may be provided to a device with speakers such as a headphone device, user input and sensor readings may be transmitted to remote equipment, etc.

Communications such as these may be supported using wired and/or wireless communications. In an illustrative configuration, components 36 may include wireless communications circuitry for supporting wireless communications between device 10 and remote wireless equipment (e.g., a cellular telephone, a wireless base station, a computer, headphones or other accessories, a remote control, peer devices, internet servers, and/or other equipment). Wireless communications may be supported using one or more antennas operating at one or more wireless communications frequencies. In an illustrative configuration, one or more antennas may be coupled to wireless transceiver circuitry. The wireless transceiver circuitry may include transmitter circuitry configured to transmit wireless communications signals using the antenna(s) and receiver circuitry configured to receive wireless communications signals using the antenna(s).

The wireless circuitry of device 10 may be formed from one or more integrated circuits, power amplifier circuitry, low-noise input amplifiers, passive RF components, one or more antennas, transmission lines, and other circuitry for handling RF wireless signals. The wireless circuitry may include radio-frequency transceiver circuitry for handling various radio-frequency communications bands. For example, the wireless circuitry of device 10 may include wireless local area network (WLAN) and wireless personal area network (WPAN) transceiver circuitry. This transceiver circuitry may handle 2.4 GHz and 5 GHz bands for WiFi® (IEEE 802.11) communications and other WLAN communications and the 2.4 GHz Bluetooth® communications band or other WPAN bands and may sometimes be referred to herein as WLAN/WPAN transceiver circuitry or local transceiver circuitry.

The wireless circuitry of device 10 may use remote wireless circuitry such as cellular telephone transceiver circuitry for handling wireless communications in frequency ranges (communications bands) such as a cellular low band (LB) from 600 to 960 MHz, a cellular low-midband (LMB) from 1410 to 1510 MHz, a cellular midband (MB) from 1710 to 2170 MHz, a cellular high band (HB) from 2300 to 2700 MHZ, a cellular ultra-high band (UHB) from 3300 to 5000 MHz, or other communications bands between 600 MHz and 5000 MHz. If desired, the cellular telephone transceiver circuitry may support 5G communications using a low band at 600-850 MHz, a mid-band at 2.5-3.7 GHZ, and a high band at 25-39 GHz. Wireless communications may also be provided using other frequency ranges (e.g., frequencies above 100 MHz, above 1 GHz, 1-30 GHz, 100 Mhz-300 GHz, 24 GHz, less than 300 GHz, less than 100 GHz, 10-300 GHz or other mm-wave frequencies, and/or other suitable frequencies). WLAN/WPAN transceiver circuitry and/or cellular transceiver circuitry may handle voice data and non-voice data.

If desired, the antennas and other wireless circuitry of device 10 may include satellite navigation system circuitry such as Global Positioning System (GPS) receiver circuitry for receiving GPS signals at 1575 MHz or for handling other satellite positioning data (e.g., GLONASS signals at 1609 MHz). Satellite navigation system signals are received from a constellation of satellites orbiting the earth. Wireless circuitry in device 10 can include circuitry for other short-range (local) and long-range (remote) wireless links if desired. For example, wireless circuitry in device 10 may be provided to receive television and radio signals, paging signals, near field communications (NFC) signals at 13.56 MHz or other suitable NFC frequencies, ultrawideband (UWB) signals (e.g., UWB signals from 6-8.5 GHZ, UWB signals from 3.5-9 GHz, etc.). Wireless circuitry in device 10 may also include antennas and transceiver for handling sensing applications (e.g., radar). If desired, antennas may be provided in arrays (e.g., phased antenna arrays) that support beam steering. These arrangements and other arrangements may be used in supporting wireless communications, wireless sensing, wireless location services, wireless power, and other wireless operations.

The wireless circuitry of device 10 may include antennas that are formed using any suitable antenna types. For example, the antennas of device 10 may include antennas with resonating elements that are formed from slot antenna structures, loop antenna structures, patch antenna structures, stacked patch antenna structures, antenna structures having parasitic elements, inverted-F antenna structures, planar inverted-F antenna structures, helical antenna structures, monopole antennas, dipole antenna structures, Yagi (Yagi-Uda) antenna structures, surface integrated waveguide structures, coils, hybrids of these designs, etc. If desired, one or more of the antennas may be cavity-backed antennas.

Different types of antennas may be used for different bands and combinations of bands. For example, one type of antenna may be used in forming a local wireless link antenna whereas another type of antenna is used in forming a remote wireless link antenna. If desired, space may be conserved within device 10 by using a single antenna to handle two or more different communications bands. For example, a single antenna in device 10 may be used to handle communications in a WiFi® or Bluetooth® communication band while also handling communications at one or more cellular telephone frequencies. In some configurations, some cellular telephone communications (e.g., low-band and mid-band communications) may be handled using a first antenna (e.g., an inverted-F antenna), whereas other communications (e.g., high-band communications) may be handled using one or more phased antenna arrays (e.g., multiple linear patch antenna arrays each of which is mounted in a different orientation and each of which has a different angle of view so that a desired amount of angular coverage is achieved).

To provide antenna structures in device 10 with the ability to cover different frequencies of interest, one or more of the antennas of device 10 may be provided with circuitry such as filter circuitry (e.g., one or more passive filters and/or one or more tunable filter circuits). Discrete components such as capacitors, inductors, and resistors may be incorporated into the filter circuitry. Capacitive structures, inductive structures, and resistive structures may also be formed from patterned metal structures (e.g., part of an antenna). If desired, antenna(s) in device 10 may be provided with adjustable circuits such as tunable components that tune the antenna over communications (frequency) bands of interest. The tunable components may be part of a tunable filter or tunable impedance matching network, may be part of an antenna resonating element, may span a gap between an antenna resonating element and antenna ground, etc.

Radio-frequency transmission line paths may be used to convey antenna signals between the radio-frequency transceiver circuitry of device 10 and the antenna(s) of device 10. These paths may include one or more radio-frequency transmission lines (sometimes referred to herein simply as transmission lines). Radio-frequency transmission line paths may each include a positive signal conductor and a ground signal conductor. Transmission lines in device 10 may include coaxial cable transmission lines, stripline transmission lines, microstrip transmission lines, edge-coupled microstrip transmission lines, edge-coupled stripline transmission lines, transmission lines formed from waveguide structures (e.g., coplanar waveguides or grounded coplanar waveguides), combinations of these types of transmission lines and/or other transmission line structures.

If desired, matching networks may be used to help match impedances in the wireless circuitry of device 10. A matching network may, for example, include components such as inductors, resistors, and capacitors configured to match the impedance of an antenna to the impedance of an associated radio-frequency transmission line path that is used in coupling the antenna to a transceiver. Matching network components may be provided as discrete components (e.g., surface mount technology components) or may be formed from housing structures, printed circuit board structures, traces on plastic supports, etc. Components such as these may also be used in forming antenna filter circuitry and may be tunable and/or fixed components.

Radio-frequency transmission line paths may be coupled to antenna feed structures associated with antennas in device 10. As an example, an antenna in device 10 such as an inverted-F antenna, a planar inverted-F antenna, a patch antenna, a loop antenna, or other antenna may have an antenna feed with a positive antenna feed terminal and a ground antenna feed terminal. The positive antenna feed terminal may be coupled to an antenna resonating (radiating) element within the antenna. The ground antenna feed terminal may be coupled to an antenna ground in the antenna. The positive feed terminal may be coupled to a positive signal line in a transmission line and the ground feed terminal may be coupled to a ground signal line in the transmission line.

Other types of antenna feed arrangements may be used if desired. For example, an antenna may be fed using multiple feeds each coupled to a respective port of a transceiver over a corresponding transmission line. If desired, a given transmission line signal conductor may be coupled to multiple locations on an antenna and/or switches may be interposed within the paths between a transceiver and the feed terminals of an antenna.

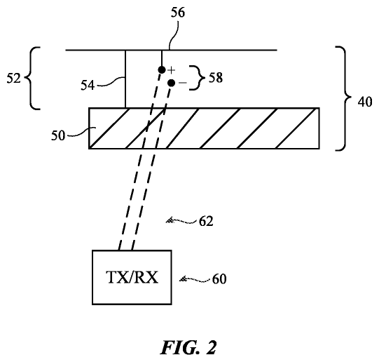

FIG. 2 is a diagram of illustrative wireless communications circuitry for device 10. As shown in FIG. 2, the wireless circuitry includes radio-frequency transceiver 60, which is coupled to antenna 40 by transmission line 62. Antenna 40 may have an antenna resonating element 52 and antenna ground 50. Antenna resonating element 52 may be formed from any suitable antenna resonating element structures. In the example of FIG. 2, antenna resonating element 52 is an inverted-F antenna resonating element having resonating element arm 56, which is coupled to ground 50 by return path 54 and which is fed using antenna feed 58. Feed 58 has positive and ground feed terminals coupled respectively to positive and ground signal lines in transmission line 62. Conductive structures making up antenna 40 may be formed from thin-film metal traces on printed circuits (e.g., rigid printed circuit boards formed from fiberglass-filled epoxy and other rigid printed circuit board substrate material and/or flexible printed circuits formed from sheets of polyimide or other flexible polymer substrates), metal traces on molded polymer antenna substrates, metal traces on other dielectric substrates, metal foil, conductive structural members such as portions of a housing for device 10 (e.g., a metal chassis and/or other internal and/or external frame structures, metal housing walls, metal component support brackets, and/or other conductive housing structures), and/or other structures in device 10 that are formed from metal and/or other conductive material.

Antennas may be mounted within device 10 using mounting brackets, using biasing structures that press antenna components against housing structures, using adhesive, using screws and other fasteners, using press-fit connections, using solder, welds, conductive adhesive, and/or other conductive attachment mechanisms, and/or other mounting arrangements. Due to the order of assembly of device components (e.g., due to the desire to assemble some components such as a display cover layer and/or other housing structures after other structures such as the rear of housing 12 and optical modules 16 have been assembled), it may be desirable to mount an antenna using a compressible structure such as a layer of foam or other biasing member that helps bias the antenna towards a known (reference) location in the device when the display cover layer or other housing structure is attached to other device structures.

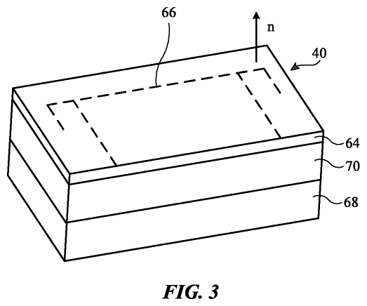

Consider, as an example, the illustrative antenna mounting structures of FIG. 3. As shown in FIG. 3, antenna 40 may be formed from antenna substrate 64 (e.g., a flexible printed circuit or other substrate, which may be planar, as shown in FIG. 3, or which may have a curved developable surface and/or a surface of compound curvature). Antenna substrate 64 contains metal traces 66 that have been patterned to form antenna resonating element 52 and/or other antenna structures.

Antenna 40 may be mounted in interior 42 using an antenna support member such as support member 68 (sometimes referred to as a support structure or support). Support member 68 may be formed from polymer, glass, ceramic, or other dielectric and/or other materials (e.g., metal, etc.) and/or combinations of these materials. A biasing member such as member 70 (sometimes referred to as a biasing structure) may be located between antenna 40 and support member 68. Member 70 may be formed from a compressible structure (e.g., one or more springs, foam layers, elastomeric polymer layers, and/or other structures that can exhibit a restoring force when compressed). This allows member 70 to provide a biasing force that helps hold antenna 40 (e.g., substrate 64) against the inner surface of cover layer 12CG and/or other portions of device 10 such as other housing structures. As an example, member 68 may be mounted in device 10 so that antenna 40 faces outwardly towards front F (e.g., in the +Y direction away from eye boxes 34). After mounting member 68 in this way, one or more additional layers of material may be installed in device 10 (e.g., by attaching such layer(s) to housing sidewalls and/or other housing structures). The layers of material that are installed in this way (which may sometimes be referred to as housing layers) may include cosmetic covering layers (e.g., a ring-shaped cover, sometimes referred to as a shroud or shroud trim, that runs around the border of display 20, a tinted polymer layer that covers display 20 on the front of device 10 (sometimes referred to as a shroud canopy), display cover layer 12CG, and/or other layer(s) of material. During installation of one or more of these housing layers (e.g., layer 12CG, shroud layer(s), etc.), a curved inner surface or other inner surface of layer 12CG and/or other housing layer(s) may contact antenna 40 and may press antenna 40 towards member 68. This compresses biasing member 70, which generates a restoring force (biasing force) that helps hold antenna 40 in place against the inner surface of layer 12CG and/or other overlapping housing layers. In this way, the location of antenna 40 relative to layer 12CG and/or other housing layers may be reliably established.

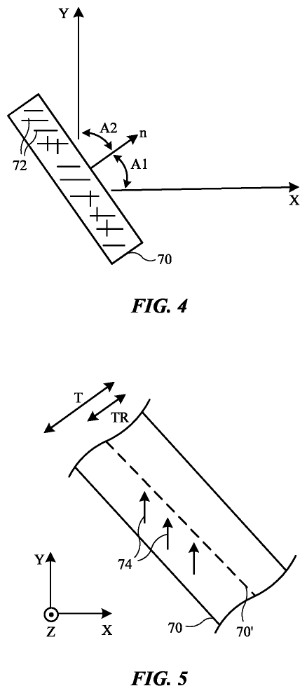

Substrate 64 may be formed from a layer with opposing first and second sides characterized by respective surface normals (see, e.g., surface normal n). In configurations in which antenna 40 (e.g., substrate 64) and member 70 are compressed in a direction parallel that is parallel to the surface normal n of antenna 40 and substrate 64, member 70 will compress in the absence of sheering forces (off-axis forces with respect to surface normal n). In some configurations, however, the inner surface of layer 12CG (or other structure against which antenna 40 is being placed) may exert force on antenna 40 and member 70 in a direction that is orientated at a non-zero angle (see, e.g., angle A2 of FIG. 4, which may be between 10º and 80º, between 20° and 70°, etc.) with respect to surface normal n. For example, the inner surface of layer 12CG may be angled with respect to the Y axis. As a result, sheering forces may be generated that give rise to uncertainty in the lateral placement (location along the X axis) of antenna 40 after an overlapping layer such as layer 12CG and/or other overlapping housing layer(s) has been assembled into device 10.

To overcome undesired lateral movement of antenna 40 in response to installation of layer 12CG or other overlapping layer(s) and associated application of force from layer 12CG or other overlapping layer(s) onto antenna 40 and member 70, member 70 may be formed from a compressible structure that exhibits preferential compression along an axis (sometimes referred to as a compression axis, unidirectional compression axis, axis of compression, axis of preferential compression, preferential axis of compression, or unidirectional axis of compression) that is not parallel to surface normals such as surface normal n that are associated with the inner surface of the display cover layer, the surfaces of the antenna substrate, and the adjacent surface of member 70.

The use of a biasing member with a preferential axis of compression that is not parallel to surface normal n shown in FIG. 4. In the example of FIG. 4, member 70 has been formed from a polymer such as polymer foam (e.g., elastomeric open-cell and/or closed-cell foam). Fibers 72 (e.g., strands of polymer, glass, carbon, or other materials) have been embedded into member 70. Most or all of fibers 72 extend parallel to the X axis of FIG. 4, which is perpendicular to the Y axis of FIG. 4, and/or the lengths of fibers 72 that run parallel to the X axis are longer than those of fibers 72 that run parallel to the Y axis. The presence of fibers 72 helps preferentially stiffen and reduce compressibility in member 70 along the direction in which fibers 72 are aligned). As a result, the foam material of member 70 of FIG. 4 exhibits elevated resistance to compression along the X axis (oriented at a non-zero angle A1 with respect to surface normal n in the example of FIG. 4) and exhibits lowered (e.g., less) resistance to compression along the Y axis (oriented at a non-zero angle A2 with respect to surface normal n in the example of FIG. 4). The Y axis in this example serves as the preferential axis of compression for member 70. Because member 70 compresses and stretches along the Y axis but does not significantly compress or stretch along the X axis, which is orthogonal to the Y axis, member 70 may sometimes be referred to as unidirectional structural foam antenna biasing member (unidirectional structural foam antenna biasing structure) or unidirectional antenna biasing member (unidirectional antenna biasing structure).

FIG. 5 is a diagram illustrating the behavior of member 70 of FIG. 4 when exposed to applied force along the Y axis (e.g., a direction that is at a non-zero angle A2 with respect to surface normal n). Initially, member 70 is uncompressed and has thickness T. After compression, member 70 has reduced thickness TR. Due to the presence of fibers 72 (FIG. 4) and/or other structures that promote uniaxial expansion and contraction, when force is applied to the surfaces of member 70 along the Y axis, member 70 compresses in direction 74 along the Y axis from its initially uncompressed state to a compressed state (see, e.g., compressed member shape 70′ of FIG. 5). During these compression activities, compression occurs along the Y axis and not the orthogonal X axis. As a result, the opposing outwardly facing and inwardly facing surfaces of member 70 do not shift laterally (e.g., there is no movement of these surfaces relative to each other along the X axis). This helps ensure that antenna 40 is mounted in a desired location in device 10 and does not experience undesirable lateral movement during assembly.

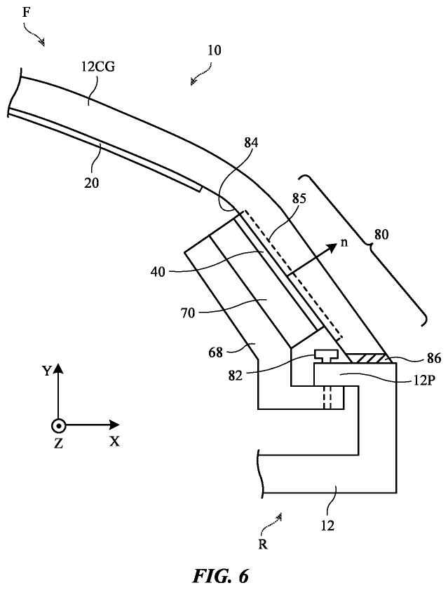

FIG. 6 shows how the uniaxial compression properties of member 70 may be used to help ensure satisfactory placement of antenna 40 within device 10. As shown in FIG. 6, forward-facing display 20 may be mounted under display cover layer 12CG, so that images on display 20 may be viewed on front F of device 10. If desired, an air gap may separate display 20 from display cover layer 12CG. One or more additional structures (e.g., a shroud having a ring-shaped trim portion that surrounds the pixels of display 20 and having a canopy portion that covers the pixels of display 20) may optionally be located between display cover layer 12CG and antenna 40, as shown by illustrative dielectric layer(s) 85. As an example, device 10 may include an internal housing structure such as a polymer structure forming a shroud (e.g., layer 85 may be a polymer should layer) and this layer may be interposed between layer 12CG and antenna 40. The shroud in this type of arrangement may have a ring shape that extends around the periphery of display 20 and/or may have portions that overlap display 20. In general, antenna 40 may be overlapped by any structure having a surface (e.g., an inner surface) against which antenna 40 is mounted. The overlapping structure, which may be a housing structure such as display cover layer 12CG, a shroud trim member, a shroud canopy, or other polymer layer, a dielectric housing wall, and/or any other dielectric member (sometimes referred to as a housing structure or housing layer), may have an inwardly facing surface against which antenna 40 is mounted. In the illustrative configuration of FIG. 6, the housing layer that overlaps antenna 40 is display cover layer 12CG (or, in the situation where optional interposed layer 85 is present, the layer that overlaps antenna 40 is a polymer layer that is between layer 12CG and antenna 40). These are illustrative examples. In general, any suitable polymer layer or other dielectric structure may overlap antenna 40 and may have a surface against which antenna 40 may be mounted during assembly of device 10.

In the illustrative configuration of FIG. 6, antenna 40 is mounted in device 10 in peripheral (edge) region 80 (on the right side of device 10 in the example of FIG. 6) under layer 12CG. Layer 12CG (and/or other housing structures overlapping antenna 40) may be planar or may be curved and may be tilted to the right sufficiently to create a region of surface 84 with a surface normal that is angled with respect to the X and Y axes of FIG. 6 (see, e.g., surface normal n of antenna 40, which is parallel to the surface normal of surface 84 in region 80). Because region 80 is angled away from the central portion of layer 12CG (or other overlapping dielectric layer) and may have a curved cross-sectional profile, region 80 may sometimes be referred to as forming a curved edge portion of layer 12CG or a curved edge portion of other overlapping housing layer.

Antenna 40 is attached (e.g., with adhesive) to biasing member 70 (e.g., a layer of unidirectional structural foam of the type descried in connection with FIGS. 4 and 5 that is configured to serve as an antenna biasing member). Member 70 has a first side that faces antenna 40 and an opposing second side that faces support member 68. Member 70 is attached (e.g., with adhesive) to support member 68. Support member 68, in turn, is mounted to housing 12 (e.g., fastener 82 may be used to attach member 68 to portion 12P of housing 12 and/or other attachment mechanisms may be used to secure member 68 relative to housing 12 on rear R and/or elsewhere in device 10). When device 10 is assembled, there is generally slight compression of member 70 (e.g., along the Y axis), which creates a restoring force outward against inner surface 84. The arrangement of FIG. 6 therefore places antenna 40 in a known spatial relationship with overlapping structures such display cover layer 12CG (e.g., in direct contact with surface 84), thereby eliminating uncertainty in the distance between antenna 40 and layer 12CG. This may help avoid the possibility of forming variable-size air gaps between antenna 40 and surface 84, which could have varying impacts on antenna performance. Layer 12CG and/or other overlapping housing structures (e.g., a polymer shroud layer or other polymer layer) is preferably formed from a dielectric such as glass or polymer, so radio-frequency antenna signals for antenna 40 may pass through portion 80 of layer 12CG or other overlapping layer.

Antenna performance, which is affected by the distance between antenna 40 and the structures of device 10, and the reliability of the mounting arrangement shown in FIG. 6 could potentially be adversely affected by undesired lateral movement of antenna 40 relative to its nominal position under portion 80. This lateral movement is prevented by using uniaxial foam in forming member 70. During assembly of device 10, antenna 40, member 70, and member 68 are initially mounted to housing 12. In this initial state, the front wall of housing 12 (e.g., cover layer 12CG in the current example) may not be present. After components 36 have been installed within housing 12, cover layer 12CG and/or other overlapping housing layer(s) may be moved in the −Y direction and mounted to housing 12 (e.g., using adhesive layer 86, using fasteners, and/or using other attachment structures). Because surface normal n of antenna 40 and the opposing surface normal of surface 84 in edge region 80 are at a non-zero angle with respect to the Y axis (see, e.g., angle A2 of FIG. 4), movement of layer 12CG in the −Y direction creates a lateral force on antenna 40 and member 70 along the X axis that has the potential to compress member 70 laterally. Nevertheless, because member 70 is formed from unidirectional structural foam that preferentially compresses along the Y axis, this lateral movement (movement parallel to the X axis) is prevented. Rather, as layer 12CG (or other overlapping dielectric housing structure) is mounted to housing 12 and presses inwardly on antenna 40, member 70 compresses only along the Y axis. As a result, antenna 40 moves slightly in the −Y direction when pressed by surface 84, but does not shift position relative to the X axis. This ensures that antenna 40 is located satisfactorily in device 10 relative to housing 12 (which may include, for example, metal structures such as a metal chassis that forms some or all of antenna ground 50 of FIG. 2). Satisfactory performance of antenna 40 may therefore be achieved.

Although sometimes described herein in the context of an antenna biasing member in a head-mounted device, unidirectional structural foam or other compressible structures with a unidirectional axis of compression may be used in other contexts and/or devices. As an example, unidirectional structural foam may be used in device 10 for sound management (e.g., to exhibit preferential sound channeling along a particular direction), may be used for directional vibration absorption (perpendicular to the axis of fibers 72), may be used to exhibit directional electrical conductivity (e.g., for sensing and signal routing applications, and/or may otherwise be used in electronic devices that can benefit from elevated control of antenna placement and/or elevated control of the placement of other device components.

In some embodiments, sensors may gather personal user information. To ensure that the privacy of users is preserved, all applicable privacy regulations should be met or exceeded and best practices for handling of personal user information should be followed. Users may be permitted to control the use of their personal information in accordance with their preferences.

In accordance with an embodiment, an electronic device is provided that includes an antenna support, an antenna having a substrate characterized by a surface normal, and unidirectional foam that has an axis of preferential compression that is orientated at a non-zero angle with respect to the surface normal and that is coupled between the antenna support and the antenna.

In accordance with another embodiment, the electronic device includes a display and a housing having a portion forming a display cover layer with an inner surface, the display cover layer overlaps the display, the antenna support is coupled to the housing, and the unidirectional foam is configured to press the substrate towards the inner surface.

In accordance with another embodiment, the unidirectional foam is configured to compress along the axis of preferential compression in response to the pressing of the antenna towards the inner surface and is configured to resist compression orthogonal to the axis of preferential compression.

In accordance with another embodiment, the housing includes a head-mounted housing.

In accordance with another embodiment, the electronic device includes optical modules coupled to the head-mounted housing that are configured to display images to eye boxes.

In accordance with another embodiment, the unidirectional foam has fibers embedded in foam, is configured to compress along the axis of preferential compression, and is configured to resist compression orthogonal to the axis of preferential compression.

In accordance with another embodiment, the electronic device includes a display and a display cover layer that covers the display, the unidirectional foam is configured to press the substrate towards the display cover layer.

In accordance with another embodiment, the unidirectional foam includes fibers oriented orthogonal to the axis of preferential compression.

In accordance with another embodiment, the display cover layer has an edge portion with a curved cross-sectional profile.

In accordance with another embodiment, the unidirectional foam is configured to press the substrate towards the edge portion.

In accordance with an embodiment, an antenna assembly is provided that includes an antenna substrate characterized by a surface normal, antenna traces on the substrate, an antenna support and foam that has an axis of preferential compression orientated at a non-zero angle with respect to the surface normal and that is coupled between the antenna support structure and the antenna.

In accordance with another embodiment, the foam includes unidirectional foam that contains fibers.

In accordance with another embodiment, the foam includes fibers oriented along an axis that is orthogonal to the axis of preferential compression to restrict compression along the axis that is orthogonal to the axis of preferential compression.

In accordance with another embodiment, the antenna substrate includes a printed circuit substrate having opposing first and second surfaces and the surface normal is perpendicular to the first surface.

In accordance with an embodiment, a head-mounted device is provided that includes a head-mounted housing, an antenna mounted within the head-mounted housing and a compressible layer having opposing first and second surfaces, the antenna is coupled to the first surface, the first surface is characterized by a surface normal, and the compressible layer is characterized by an axis of preferential compression that is oriented at a non-zero angle with respect to the surface normal.

In accordance with another embodiment, the head-mounted device includes a support configured to compress the compressible layer along the axis of preferential compression.

In accordance with another embodiment, the head-mounted housing has a layer of material with an inner surface and the compressible layer is configured to press the antenna against the inner surface.

In accordance with another embodiment, the layer of material includes a layer of dielectric.

In accordance with another embodiment, the head-mounted device includes a display, the layer of dielectric overlaps the display.

In accordance with another embodiment, the layer of dielectric has an edge portion with a curved cross-sectional profile, the compressible layer includes a layer of foam with embedded fibers oriented orthogonal to the axis of preferential compression, and the compressible layer is configured to press the antenna towards an inner surface of the edge portion.

The foregoing is merely illustrative and various modifications can be made to the described embodiments. The foregoing embodiments may be implemented individually or in any combination.

What is claimed is:

1. An electronic device, comprising:
an antenna support;
an antenna having a substrate characterized by a surface normal; and
unidirectional foam that has an axis of preferential compression that is orientated at a non-zero angle with respect to the surface normal and that is coupled between the antenna support and the antenna.

2. The electronic device defined in claim 1 further comprising:
a display; and
a housing having a portion forming a display cover layer with an inner surface, wherein the display cover layer overlaps the display, wherein the antenna support is coupled to the housing, and wherein the unidirectional foam is configured to press the substrate towards the inner surface.

3. The electronic device defined in claim 2 wherein the unidirectional foam is configured to compress along the axis of preferential compression in response to the pressing of the antenna towards the inner surface and is configured to resist compression orthogonal to the axis of preferential compression.

4. The electronic device defined in claim 3 wherein the housing comprises a head-mounted housing.

5. The electronic device defined in claim 4 further comprising optical modules coupled to the head-mounted housing that are configured to display images to eye boxes.

6. The electronic device defined in claim 1 wherein the unidirectional foam has fibers embedded in foam, is configured to compress along the axis of preferential compression, and is configured to resist compression orthogonal to the axis of preferential compression.

7. The electronic device defined in claim 1 further comprising:
a display; and
a display cover layer that covers the display, wherein the unidirectional foam is configured to press the substrate towards the display cover layer.

8. The electronic device defined in claim 7 wherein the unidirectional foam comprises fibers oriented orthogonal to the axis of preferential compression.

9. The electronic device defined in claim 8 wherein the display cover layer has an edge portion with a curved cross-sectional profile.

10. The electronic device defined in claim 9 wherein the unidirectional foam is configured to press the substrate towards the edge portion.

11. An antenna assembly, comprising:
an antenna substrate characterized by a surface normal;
antenna traces on the substrate;
an antenna support; and
foam that has an axis of preferential compression orientated at a non-zero angle with respect to the surface normal and that is coupled between the antenna support structure and the antenna.

12. The antenna assembly defined in claim 11 wherein the foam comprises unidirectional foam that contains fibers.

13. The antenna assembly defined in claim 11 wherein the foam comprises fibers oriented along an axis that is orthogonal to the axis of preferential compression to restrict compression along the axis that is orthogonal to the axis of preferential compression.

14. The antenna assembly defined in claim 13 wherein the antenna substrate comprises a printed circuit substrate having opposing first and second surfaces and wherein the surface normal is perpendicular to the first surface.

15. A head-mounted device, comprising:
a head-mounted housing;
an antenna mounted within the head-mounted housing; and
a compressible layer having opposing first and second surfaces, wherein the antenna is coupled to the first surface, wherein the first surface is characterized by a surface normal, and wherein the compressible layer is characterized by an axis of preferential compression that is oriented at a non-zero angle with respect to the surface normal.

16. The head-mounted device defined in claim 15 further comprising a support configured to compress the compressible layer along the axis of preferential compression.

17. The head-mounted device defined in claim 16 wherein the head-mounted housing has a layer of material with an inner surface and wherein the compressible layer is configured to press the antenna against the inner surface.

18. The head-mounted device defined in claim 17 wherein the layer of material comprises a layer of dielectric.

19. The head-mounted device defined in claim 18 further comprising a display, wherein the layer of dielectric overlaps the display.

20. The head-mounted device defined in claim 19 wherein the layer of dielectric has an edge portion with a curved cross-sectional profile, wherein the compressible layer comprises a layer of foam with embedded fibers oriented orthogonal to the axis of preferential compression, and wherein the compressible layer is configured to press the antenna towards an inner surface of the edge portion.
